(19) United States
(12) Patent Application Publication
(10) Pub. No.: US 2024/0312742 A1
(43) Pub. Date: Sep. 19, 2024

(54) Temperature Switch

(71) Applicant: UCHIYA THERMOSTAT CO., LTD., Saitama (JP)

(72) Inventor: Hideaki Takeda, Saitama (JP)

(73) Assignee: UCHIYA THERMOSTAT CO., LTD., Saitama (JP)

(21) Appl. No.: 18/576,483

(22) PCT Filed: Jul. 6, 2022
(86) PCT No.: PCT/JP2022/026797

§ 371 Date: Jan. 4, 2024

(30) Foreign Application Priority Data
Jul. 9, 2021 (JP) 2021-114332

(51) Int. Cl. H01H 37/54

(52) U.S. Cl. CPC H01H 37/54; H01H 2037/5481

(57) ABSTRACT

There is provided a temperature switch in which a thermally actuated element operates in response to heat from a thermosensitive surface unrelated to an energization path and complexity of a structure is relatively low. The temperature switch includes: a thermally actuated element configured to be inverted in warping direction at a predetermined temperature; an elastic plate structure including a movable portion moving with inversion of the thermally actuated element; a fixed contact; and a movable contact provided on the movable portion and configured to come into contact with and separate from the fixed contact. The thermally actuated element is disposed outside a current path generated when the movable contact and the fixed contact are in contact with each other.

### TECHNICAL FIELD

The present invention relates to a temperature switch for opening and closing an electric circuit by using a thermally actuated element.

### BACKGROUND ART

Patent Document 1 discloses a thin thermostat in which a movable member supporting plate obtained by cutting and bending a metal plate material holds a bimetal and realizes connection with a movable plate.

Patent Document 2 discloses a thermostat in which a current is interrupted when a ceramic pin is pressed toward a plate spring by inversion of a bimetal plate receiving heat from a case through a cap.

### CITATION LIST

### Patent Document

[Patent Document 1] JP S60-193221 A

[Patent Document 2] JP H6-5080 U

### SUMMARY OF INVENTION

### Technical Problem

In Patent Document 1, it is considered that a case surface cannot be used as a thermosensitive surface because a bimetal element as a thermally actuated element is held in a hollow portion inside a case, and is separated from the case surface. In addition, it is considered that the thermostat disclosed in Patent Document 2 includes the ceramic pin, which relatively complicates a structure.

In consideration of such a situation, an object of the present invention is to provide a temperature switch in which a thermally actuated element operates in response to heat from a thermosensitive surface unrelated to an energization path, and complexity of a structure is relatively low.

### Solution to Problem

A temperature switch according to the present invention includes: a thermally actuated element configured to be inverted in a warping direction at a predetermined temperature; an elastic plate structure including a movable portion moving with inversion of the thermally actuated element; a fixed contact; and a movable contact provided on the movable portion and configured to come into contact with, and separate from, the fixed contact. The thermally actuated element is disposed outside a current path generated when the movable contact and the fixed contact are in contact with each other.

### Advantageous Effects of Invention

According to the present invention, a temperature switch in which a thermally actuated element operates in response to heat from a thermosensitive surface unrelated to an energization path and in which complexity of the structure is relatively low can be provided.

### BRIEF DESCRIPTION OF DRAWINGS

FIG. 1A is a perspective view of a heat collection plate structure of a temperature switch according to a first embodiment as viewed from above.

FIG. 1B is a perspective view of a thermally actuated element of the temperature switch according to the first embodiment as viewed from above.

FIG. 2A is a perspective view of an elastic plate structure of the temperature switch according to the first embodiment as viewed from above.

FIG. 2B is a perspective view of the elastic plate structure of the temperature switch according to the first embodiment as viewed from below.

FIG. 3A is a perspective view of the temperature switch according to the first embodiment.

FIG. 3B is a perspective view of the temperature switch to which lead wires communicating with an external circuit are connected.

FIG. 3C is a perspective view of a case.

FIG. 4A is a cross-sectional view of the temperature switch according to the first embodiment inserted in the case.

FIG. 4B is a vertical cross-sectional view of the temperature switch according to the first embodiment inserted in the case.

FIG. 4C is another vertical cross-sectional view of the temperature switch according to the first embodiment inserted in the case.

FIG. 5A is a plan view of a temperature switch according to a second embodiment inserted in a case.

FIG. 5B is a side view of the temperature switch according to the second embodiment inserted in the case.

FIG. 6 is a perspective view of a heat collection plate structure of a temperature switch according to a third embodiment as viewed from above.

FIG. 7A is a cross-sectional view of the temperature switch according to the third embodiment inserted in a case.

FIG. 7B is a vertical cross-sectional view of the temperature switch according to the third embodiment inserted in the case.

FIG. 7C is another vertical cross-sectional view of the temperature switch according to the third embodiment inserted in the case.

### DESCRIPTION OF EMBODIMENTS

The present invention is described below based on illustrated embodiments. However, the present invention is not limited to the embodiments described below.

### First Embodiment

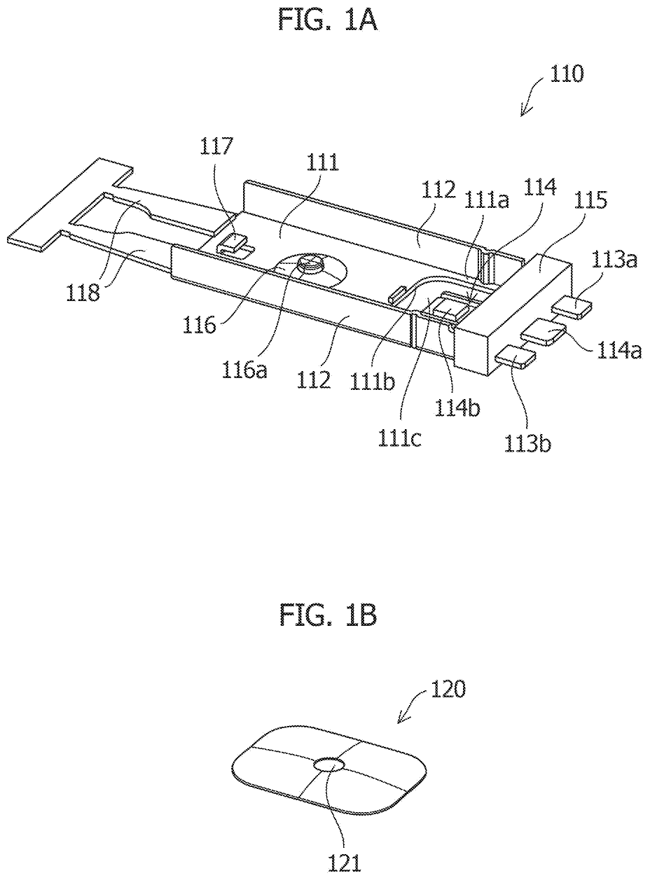

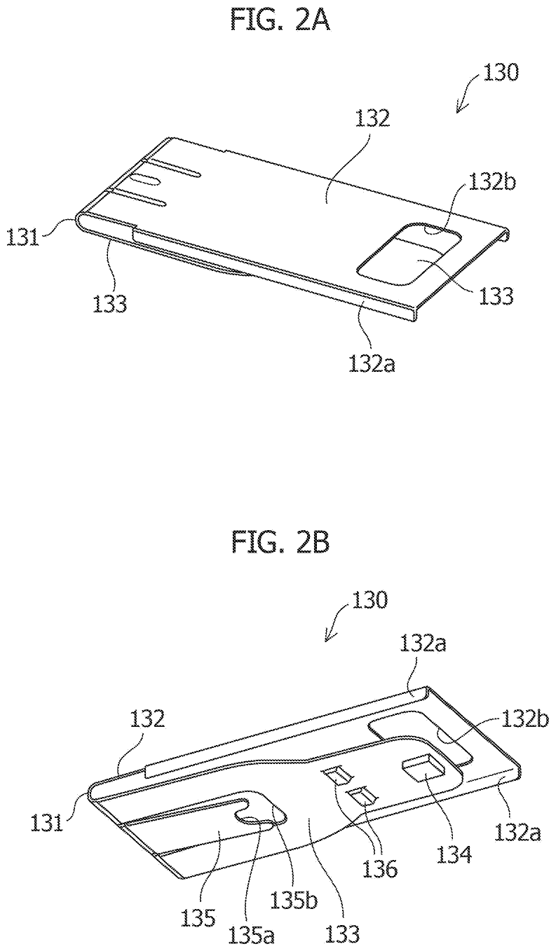

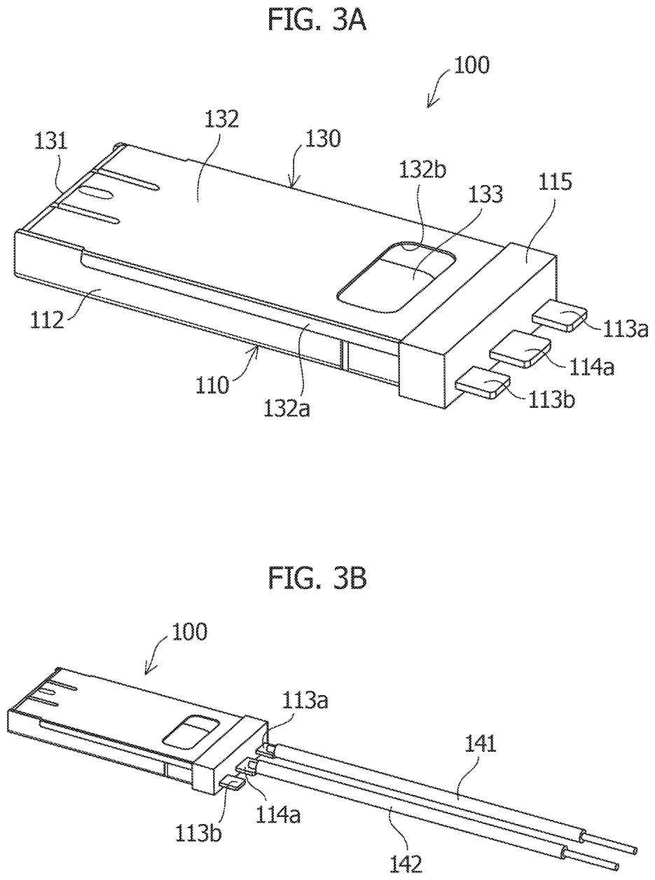

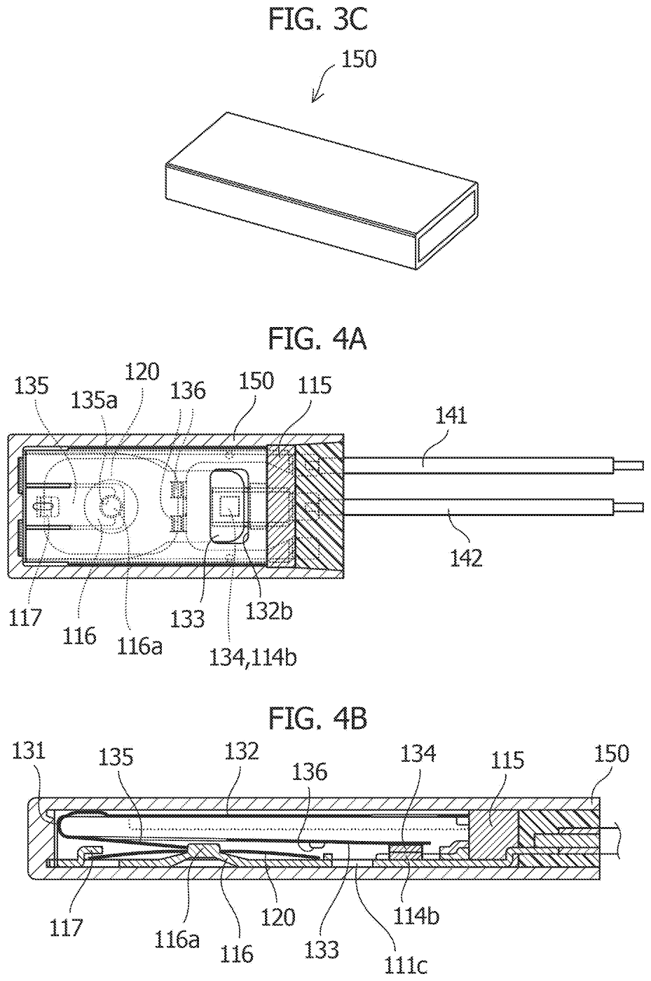

As illustrated in FIG. 1A, FIG. 1B, FIG. 2A, FIG. 2B, FIG. 3A, FIG. 3B, and FIGS. 4A to 4C, a temperature switch 100 includes a heat collection plate structure 110, a thermally actuated element 120, and an elastic plate structure 130.

As illustrated in FIG. 1A, the heat collection plate structure 110 includes a rectangular heat collection plate main body portion 111. At one end part of the heat collection plate main body portion 111 in a longitudinal direction, one end part 111a and the other end part in a width direction protrude outward in the longitudinal direction, and a center part 111b in the width direction is recessed inward in the longitudinal direction. As a result, a notch portion 111c is provided so as to be sandwiched among the one end part 111a, the other end part, and the center part 111b in the width direction. As described above, the one end part of the heat collection plate main body portion 111 in the longitudinal direction is formed in a substantially U-shape in plan view.

The heat collection plate main body portion 111 includes peripheral wall portions 112 standing upward from respective edge parts in a width direction.

A first external terminal 113a and a second external terminal 113b are respectively provided on the outside in the longitudinal direction of the one end part 111a and the other end part in the width direction.

The heat collection plate structure 110 further includes a fixed contact structure 114. The fixed contact structure 114 is a substantially rectangular plate member, and includes a third external terminal 114a provided on one end side in the longitudinal direction, and a fixed contact 114b provided on the other end side in the longitudinal direction.

A size and arrangement of the fixed contact structure 114 are determined such that the third external terminal 114a is sandwiched between the first external terminal 113a and the second external terminal 113b with intervals from both external terminals and the fixed contact 114b is disposed inside the notch portion 111c. The fixed contact structure 114, and the one end part 111a and the other end part of the heat collection plate main body portion 111 in the width direction are fixed by an insulation block portion 115 made of a resin.

A dome portion 116 protruding upward is provided between the center part 111b in the width direction and the other end part in the longitudinal direction of the heat collection plate main body portion 111. A columnar protruding portion 116a is provided at a top of the dome portion 116. Furthermore, a claw portion 117 is provided on the other end side of the dome portion 114 in the longitudinal direction on the heat collection plate main body portion 111. The claw portion 117 is provided so as to stand upward from the heat collection plate main body portion 111, and a front end part thereof is bent toward the one end side of the heat collection plate main body portion 111 in the longitudinal direction. Note that a plurality of claw portions 117 may be provided with intervals in the width direction of the heat collection plate main body portion 111.

FIG. 1B illustrates the thermally actuated element 120 such as a bimetal. The thermally actuated element 120 has a corner-rounded rectangular shape. Before inversion, as viewed from above, the thermally actuated element 120 has a convex shape in which a center part protrudes, whereas as viewed from below, the thermally actuated element 120 has a concave shape in which the center part is recessed. A hole 121 is provided at a substantially center of the thermally actuated element 120.

The thermally actuated element 120 is assembled to the heat collection plate main body portion 111 such that one end part of the thermally actuated element 120 in the longitudinal direction serves as a free end. More specifically, the protruding portion 116a is inserted into the hole 121 of the thermally actuated element 120, and the other end part of the thermally actuated element 120 in the longitudinal direction is locked by the claw portion 117. Accordingly, the one end part of thermally actuated element 120 in the longitudinal direction may be largely displaced based on the temperature with the center part as a fulcrum.

Extension portions 118 extending outward in the longitudinal direction may be provided at the other end part of the heat collection plate main body portion 111 in the longitudinal direction. When a fixing hole is provided in a case, the extension portions 118 extend up to the vicinity of the fixing hole. In a case in which no fixing hole is provided, the extension portions can be cut off.

As illustrated in FIG. 2A, the elastic plate structure 130 is obtained by bending an elongated plate member in a substantially U-shape such that both ends in the longitudinal direction are superimposed one on the other. The elastic plate structure 130 includes a fixed portion 132 disposed on one side and a movable portion 133 disposed on the other side, as viewed from a bent portion 131. The fixed portion 132 is disposed above the movable portion 133.

Peripheral wall portions 132a extending downward are provided at respective end parts of the fixed portion 132 in a width direction. In a state in which the fixed portion 132 and the peripheral wall portions 132a are superimposed so as to cover the heat collection plate main body portion 111 provided with the thermally actuated element 120 and the peripheral wall portions 112, the peripheral wall portions 132a disposed outside in the width direction and the peripheral wall portions 112 disposed inside in the width direction are connected at a plurality of positions by welding or the like.

A movable contact 134 is provided on a lower surface at a front end part of the movable portion 133. The movable contact 134 can come into contact with, and separate from, the fixed contact 114b. Furthermore, a cutout 135b in a substantially U-shape is provided at a base end part of the movable portion 133, and a tongue-piece portion 135 having the bent portion 131 as a base end is accordingly formed. An angle formed by the tongue-piece portion 135 and the fixed portion 132 is greater than an angle formed by the movable portion 133 and the fixed portion 132. A notch portion 135a in which a center part in the width direction is curved toward the base end is provided at a front end part of the tongue-piece portion 135. The notch portion 135a has a shape corresponding to parts of the protruding portion 116a and the hole 121. A portion near the center part of the thermally actuated element 120 is pressed against the dome portion 114 by elastic force of the tongue-piece portion 135.

When the thermally actuated element 120 is inverted, the movable portion 133 is lifted up, and the movable contact 134 in contact with the fixed contact 114b separates from the fixed contact 114b. A plurality of protruding portions 136 can be provided with intervals in the width direction so as to come into contact with the one end part of the thermally actuated element 120 in the longitudinal direction, between the movable contact 134 of the movable portion 133 and the cutout 135b. The plurality of protruding portions 136 can stably drive the movable portion 133 irrespective of a contact state of the movable contact 134 to the fixed contact 114b.

In a case in which only one protruding portion 136 is provided at a center in the width direction, if adhesion or light welding called sticking occurs in the contact, inversion force of the thermally actuated element escapes toward a side with low resistance, which makes it difficult to open the contacts. However, when the plurality of protruding portions 136 is provided, the inversion force of the thermally actuated element is transmitted to the entirety of the movable portion 133, which allows opening operation to be reliably performed.

At the front end part of the fixed portion 132, a hole 132b is provided so as to be disposed above the movable contact 134. When the movable portion 133 is lifted up by inversion of the thermally actuated element 120, the hole 132b prevents the front end part of the movable portion 133 from interfering with the fixed portion 132.

The temperature switch 100 is configured by metal members, has a flat box-like outer shape, and includes the thermally actuated element 120, the movable portion 133, and paired contacts, namely, the fixed contact 114b and the movable contact 134 in its internal space. Therefore, a thin shape and a structure high in rigidity can be realized.

As illustrated in FIG. 3B, the temperature switch 100 is connected to an external circuit through lead wires. A lead wire 141 is connected to the first external terminal 113a, and a lead wire 142 is connected to the third external terminal 114a. Note that the lead wire 141 may be connected not to the first external terminal 113a but to the second external terminal 113b.

The temperature switch 100 can be inserted in a box-like case 150 provided with an opening illustrated in FIG. 3C. After the temperature switch 100 is inserted, the opening of the case 150 can be filled with a curable resin such as an epoxy resin. Even in a state in which the temperature switch 100 is inserted in the case 150 and the internal structure of the temperature switch 100 is hidden, it is possible to identify which of two opposing surfaces of the case 150 in a thickness direction is disposed on the heat collection plate main body portion 111 side. In other words, when the lead wire 141 is assumed to be connected to the first external terminal 113a, and the lead wire 141 is disposed on a left side as facing a drawing-out direction of the lead wire 142 from the temperature switch 100, a bottom surface in an arrangement of the temperature switch at that time is disposed on the heat collection plate main body portion 111 side. In addition, in a case in which the lead wire 141 is disposed on a right side as facing the drawing-out direction of the lead wire 142 from the temperature switch 100 under the above-described assumption, an upper surface in the arrangement of the temperature switch at that time is disposed on the heat collection plate main body portion 111 side. As described above, which side of the heat connection plate main body portion is seen can be distinguished from appearance after the temperature switch 100 is inserted in the case. Since one of the surfaces serves as the thermosensitive surface, it is extremely important to easily distinguish the thermosensitive surface from the appearance.

The thermally actuated element 120 is present outside an energization path by the third external terminal 114a, the fixed contact 114b, the movable contact 134, the movable portion 133, the bent portion 131, the fixed portion 132, the peripheral wall portions 112, and the first external terminal 113a or the second external terminal 113b. Furthermore, as illustrated in FIG. 4C, when the temperature of the thermally actuated element 120 reaches a predetermined temperature or more and the shape thereof is inverted, the movable portion 133 is lifted up, the movable contact 134 separates from the fixed contact 114b, and a current is interrupted.

When electricity flows through a portion in which the electricity is supplied, namely, a charging portion (or metal portion), the electricity normally flows through a shortest path. The tongue-piece portion 135, the thermally actuated element 120, and the heat collection plate main body portion 111 each not having a flow-out destination of electricity do not serve as the energization path.

### Second Embodiment

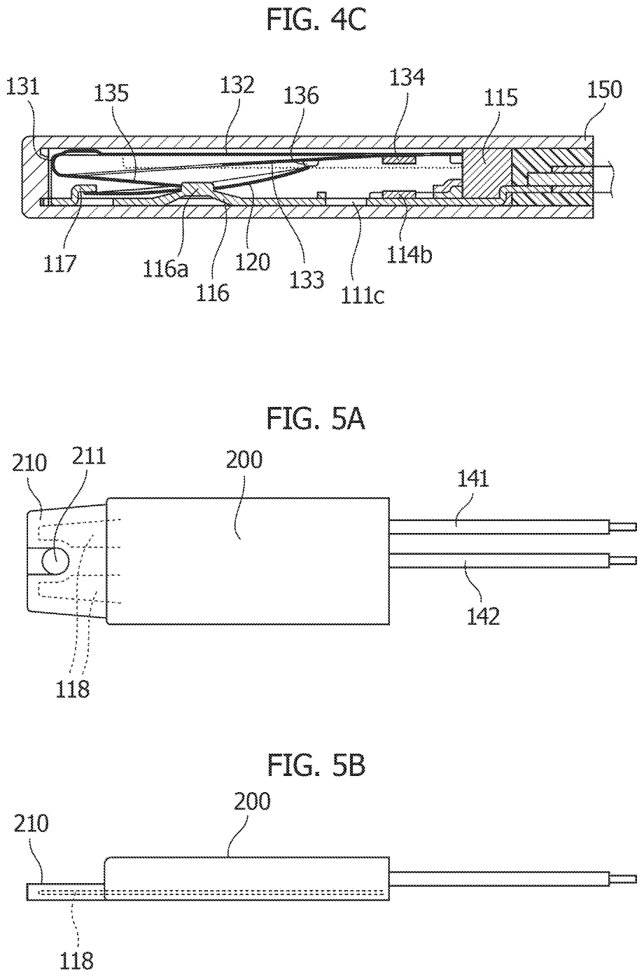

As illustrated in FIG. 5A and FIG. 5B, the paired extension portions 118 may be maintained without being cut. To handle the extension portions 118, a case 200 includes a case extension portion 210 in which the paired extension portions 118 are inserted. The case extension portion 210 includes an attachment hole 211 in a vertical direction. The hole 211 is aligned with a region between the paired extension portions 118 in the vertical direction.

As described above, the heat collection plate is extended as a whole by the paired extension portions 118, which further improves a heat collection effect.

In a case in which the temperature switch is attached to a predetermined position by using the attachment hole 211, the heat collection plate comes into tight contact with the attachment surface, and can efficiently transfer heat to the thermally actuated element.

Note that, in place of the attachment hole 211, a U-shaped notch portion opening at the front end part in the longitudinal direction may be provided. Attachment is not limited to attachment using the attachment hole 211 and a screw, and the paired extension portions 118 may be inserted into and fixed to an external attachment fitting having strength.

### Third Embodiment

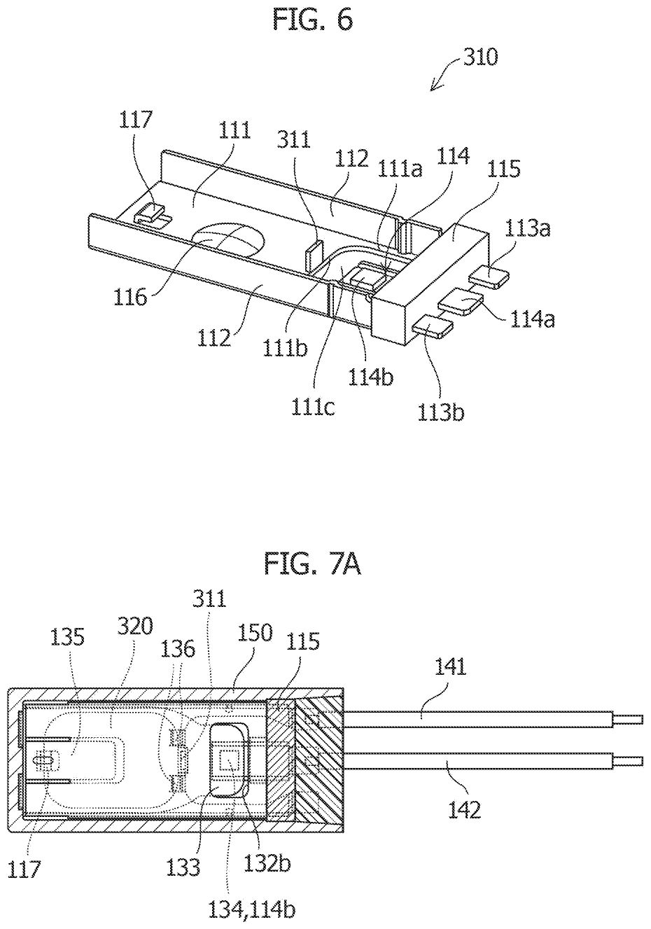

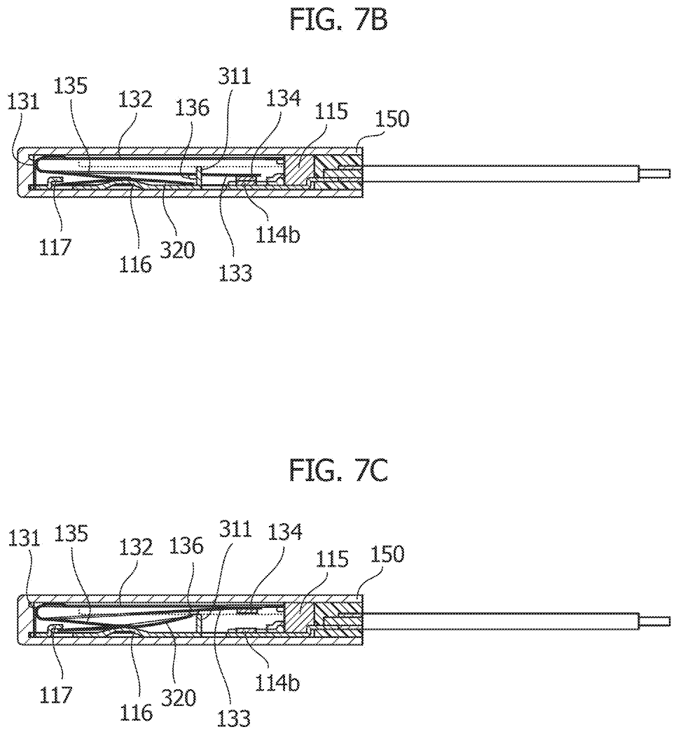

A third embodiment is illustrated in FIG. 6 and FIGS. 7A to 7C. The third embodiment is similar to the first embodiment, but no protruding portion is provided at the top of the dome 116 of the heat collection plate structure 310. Accordingly, in place of the thermally actuated element 120 including the hole, a thermally actuated element 320 including no hole is disposed on the dome 116. In other words, a protrusion for positioning the thermally actuated element and a hole at the center part of the thermally actuated element are not provided.

Instead, a wall portion 311 standing upward is provided in the width direction near the center part 111b of the heat collection plate main body portion 111 in the width direction.

Since the wall portion 311 is provided, even when the thermally actuated element 320 including no hole performs inversion operation, the thermally actuated element 320 does not jump out toward the fixed contact and the movable contact.

Alternatively, in place of the wall portion 311, an overhang portion overhung inward in the width direction may be provided on each of the peripheral wall portions 112 along an outer periphery of the thermally actuated element.

The dome 116 of the heat collection plate serves as a fulcrum when the thermally actuated element 320 is inverted. Therefore, a height of the dome 116 can be adjusted based on inversion characteristics of the thermally actuated element 320.

### Fourth Embodiment

In the above-described first embodiment, a heat insulation sheet (not illustrated) including a hole corresponding to the protruding portion 116a may be mounted between the thermally actuated element 120 and the movable portion 133 of the elastic plate structure 130. This can prevent the thermally actuated element from being influenced by Joule heat generated in the energization path. The heat insulation sheet preferably covers the entire thermally actuated element 120 except for the vicinity of the hole 121 of the thermally actuated element 120 into which the protruding portion 116a is inserted.

The heat insulation sheet can be similarly provided in the second embodiment and the third embodiment.

### Effects

According to each of the first to third embodiments, the heat collection plate outside the energization path is used as the thermosensitive surface. This enables the thermally actuated element to easily receive heat from the thermosensitive surface, and to operate in response to the heat from the thermosensitive surface. Furthermore, since the thermally actuated element is pressed against the heat collection plate by the tongue-piece portion of the elastic plate structure, thermal sensitivity is further improved.

According to each of the first to third embodiments, the thermally actuated element is disposed on the heat collection plate main body portion, and the movable portion lifted up by inversion of the thermally actuated element is disposed on the thermally actuated element. Unlike the existing technique, a ceramic pin extending in a height direction of the temperature switch is unnecessary. This allows the thickness of the temperature switch to be reduced.

According to each of the first to third embodiments, the peripheral wall portions standing from the respective edge parts of the heat collection portion in the width direction are provided, and heat can be collected from the peripheral wall portions.

According to the second embodiment, since the case extension portion for fixing the temperature switch is provided and the extension portions of the heat collection plate are provided corresponding to the case extension portion, an area of the thermosensitive surface can be further increased.

Any of the above-described temperature switches can be used for control based on a temperature. In particular, any of the above-described temperature switches can be used for control at relatively low temperature or control in a case in which a difference between an operation temperature and a return temperature is small.

The elastic plate structure 130 can be made of a spring alloy. Examples of the spring alloy include a copper alloy (phosphor bronze, beryllium copper, etc.), and stainless steel.

A material of the heat collection plate structures 110 and 310 can be a metal high in electric conductivity and thermal conductivity. Specific examples of the material include a copper, a copper alloy such as brass, and aluminum.

Any of the above-described embodiments is applicable to a thermally actuated element other than the bimetal, such as a shape-memory alloy (100° C. or less) and a trimetal.

Regarding the embodiments described above, the following supplements are disclosed.

### Supplementary Item 1

A temperature switch, including:
a thermally actuated element configured to be inverted in warping direction at a predetermined temperature;
an elastic plate structure including a movable portion moving with inversion of the thermally actuated element;
a fixed contact; and
a movable contact provided on the movable portion and configured to come into contact with and separate from the fixed contact, in which
the thermally actuated element is disposed outside a current path generated when the movable contact and the fixed contact are in contact with each other.

### Supplementary Item 2

The temperature switch according to supplementary item 1, further including a heat collection plate having an area greater than an area of the thermally actuated element, in which
the thermally actuated element is disposed on the heat collection plate, and
the thermally actuated element is pressed against the heat collection plate by elasticity of the movable portion.

### Supplementary Item 3

The temperature switch according to supplementary item 1 or 2, in which
the heat collection plate has a rectangular shape,
the heat collection plate further includes peripheral wall portions standing upward from respective edge parts of the heat collection plate in a width direction,
the elastic plate structure includes a rectangular fixed portion, and peripheral wall portions extending downward from respective edge parts of the fixed portion in the width direction are provided, and
the peripheral wall portions of the heat collection plate and the peripheral wall portions of the elastic plate structure are connected.

### Supplementary Item 4

The temperature switch according to supplementary item 3, in which the elastic plate structure is substantially U-shaped, and the movable portion and the fixed portion extend from respective ends of a bent portion of the elastic plate structure.

### Supplementary Item 5

The temperature switch according to supplementary item 4, in which
the movable portion of the elastic plate structure includes a substantially U-shaped cut,
the cut forms a tongue-piece portion having the bent portion as a base end, and
the thermally actuated element is pressed against the heat collection plate by the tongue-piece portion.

### Supplementary Item 6

The temperature switch according to any one of supplementary items 1 to 5, in which a heat collection plate extension portion is provided on one of both end parts of the heat collection plate in a longitudinal direction.

### Supplementary Item 7

The temperature switch according to any one of supplementary items 1 to 6, in which
the thermally actuated element is a bimetal, and
a heat insulation sheet is provided between the bimetal and the movable portion of the elastic plate structure.

### Supplementary Item 8

The temperature switch according to any one of supplementary items 2 to 7, in which
the heat collection plate includes a dome portion supporting the thermally actuated element, and
a wall portion standing upward from the heat collection plate is provided to extend in a width direction of the heat collection plate, between one end part of the heat collection plate in a longitudinal direction and the dome portion.

Although embodiments of the present invention are described above, the present invention is not limited to the above-described embodiments, and can be variously modified and changed based on the technical idea of the present invention.

### REFERENCE SIGNS LIST

110 Heat collection plate structure
111 Heat collection plate main body portion
112 Peripheral wall portion
113a, 113b External terminal
114 Fixed contact structure
116 Dome portion
116a Protruding portion
117 Claw portion
118 Extension portion
120 Thermally actuated element
121 Hole
130 Elastic plate structure
131 Bent portion
132 Fixed portion
132a Peripheral wall portion
133 Movable portion
134 Protruding portion
135 Tongue-piece portion
310 Heat collection plate structure
311 Wall portion
320 Thermally actuated element

1. A temperature switch comprising:
a thermally actuated element configured to be inverted in warping direction at a predetermined temperature;
an elastic plate structure including a movable portion moving with inversion of the thermally actuated element;
a fixed contact; and
a movable contact provided on the movable portion and configured to come into contact with and separate from the fixed contact, wherein
the thermally actuated element is disposed outside a current path generated when the movable contact and the fixed contact are in contact with each other.

2. The temperature switch according to claim 1, further comprising a heat collection plate having an area greater than an area of the thermally actuated element, wherein
the thermally actuated element is disposed on the heat collection plate, and
the thermally actuated element is pressed against the heat collection plate by elasticity of the movable portion.

3. The temperature switch according to claim 2, wherein
the heat collection plate has a rectangular shape,
the heat collection plate further includes peripheral wall portions standing upward from respective edge parts of the heat collection plate in a width direction,
the elastic plate structure includes a rectangular fixed portion, and peripheral wall portions extending downward from respective edge parts of the rectangular fixed portion in the width direction are provided, and
the peripheral wall portions of the heat collection plate and the peripheral wall portions of the elastic plate structure are connected.

4. The temperature switch according to claim 3, wherein the elastic plate structure is substantially U-shaped, and the movable portion and the rectangular fixed portion extend from respective ends of a bent portion of the elastic plate structure.

5. The temperature switch according to claim 4, wherein
the movable portion of the elastic plate structure includes a substantially U-shaped cut,
the substantially U-shaped cut forms a tongue-piece portion having the bent portion as a base end, and
the thermally actuated element is pressed against the heat collection plate by the tongue-piece portion.

6. The temperature switch according to claim 2, wherein a heat collection plate extension portion is provided on one of both end parts of the heat collection plate in a longitudinal direction.

7. The temperature switch according to claim 1, wherein
the thermally actuated element is a bimetal, and
a heat insulation sheet is provided between the bimetal and the movable portion of the elastic plate structure.

8. The temperature switch according to claim 2, wherein
the heat collection plate includes a dome portion supporting the thermally actuated element, and
a wall portion standing upward from the heat collection plate is provided to extend in a width direction of the heat collection plate, between one end part of the heat collection plate in a longitudinal direction and the dome portion.
